(19) United States
(12) Patent Application Publication
(10) Pub. No.: US 2006/0215411 A1
(43) Pub. Date: Sep. 28, 2006

(54) LED lamp assembly

(75) Inventor: Chin-Sung Lin, Taichung County (TW)

Correspondence Address: BACON & THOMAS, PLLC, 625 SLATERS LANE, FOURTH FLOOR, ALEXANDRIA, VA, 22314, US

(73) Assignee: TERA AUTOTECH CORPORATION, TAICHUNG HSIEN (TW)

(21) Appl. No.: 11/085,568

(22) Filed: Mar. 22, 2005

(51) Int. Cl. F21V 21/00

(52) U.S. Cl. 362/382

(57) ABSTRACT

An LED lamp assembly includes a lamp holder, which has a hollow light-transmittable shade that defines an inside chamber and a bottom opening at the bottom side of the inside chamber and a hollow base connected to the bottom side of the shade, and a light-emitting board, which has a resistor, LEDs and two contact members installed in a circuit board thereof and electrically connected to the circuit pattern of the circuit board and mounted with the circuit board inside the hollow base with the LEDs aimed at the inside chamber of the shade of the lamp holder.

### BACKGROUND OF THE INVENTION

1. Field of the Invention

The present invention relates to LEDs and more particularly, to an LED lamp assembly, which has a simple structure and is easy to install.

2. Description of the Related Art

Conventional incandescent lamps commonly use a filament (tungsten) for giving off light. However, a filament-based lamp wear quickly with use because it products much heat. Further, the brightness of a filament-based lamp is low. Nowadays, LED-based (light emitting diode-based) lamps have been intensively used in different fields to replace conventional filament-based lamps. A conventional LED lamp must be electrically connected to an additional resistor for regulating the current and voltage passing to the LED(s), assuring light emitting effect. However, the installation of a resistor in an LED lamp circuit is complicated. It requires a special mounting procedure to connect the resistor to the LED(s). This complicated mounting procedure greatly increases the cost and reduces the yield rate of the product.

### SUMMARY OF THE INVENTION

The present invention has been accomplished under the circumstances in view. It is one objective of the present invention to provide an LED lamp assembly, which has a simple structure and is easy to install.

To achieve this objective of the present invention, the LED lamp assembly provided by the present invention comprises a lamp holder and a light-emitting board mounted in the lamp holder. The lamp holder comprises a light-transmittable shade and a base at a bottom side of the shade. The shade has an inside chamber and a bottom opening at the bottom side thereof in communication with the inside chamber. The base has an inside chamber in communication with the bottom opening and the inside chamber of the shade for holding the light-emitting board. The light-emitting board comprises a circuit board, a resistor installed in the circuit board and electrically connected to the circuit pattern of the circuit board, at least one LED (light emitting diode) installed in the circuit board and electrically connected to the circuit pattern of the circuit board, and two contact members installed in the circuit board near two distal ends and electrically connected to the circuit pattern of the circuit board for electric connection to an external electricity.

### BRIEF DESCRIPTION OF THE DRAWINGS

FIG. 1 is an exploded view of an LED lamp assembly according to a preferred embodiment of the present invention.

FIG. 2 is a sectional assembly view of the LED lamp assembly according to the preferred embodiment of the present invention.

FIG. 3 is an exploded view showing the positioning of the LED lamp assembly in a control circuit board according to the present invention.

FIG. 4 is a sectional view showing the LED lamp assembly installed in the control circuit board according to the present invention.

### DETAILED DESCRIPTION OF THE INVENTION

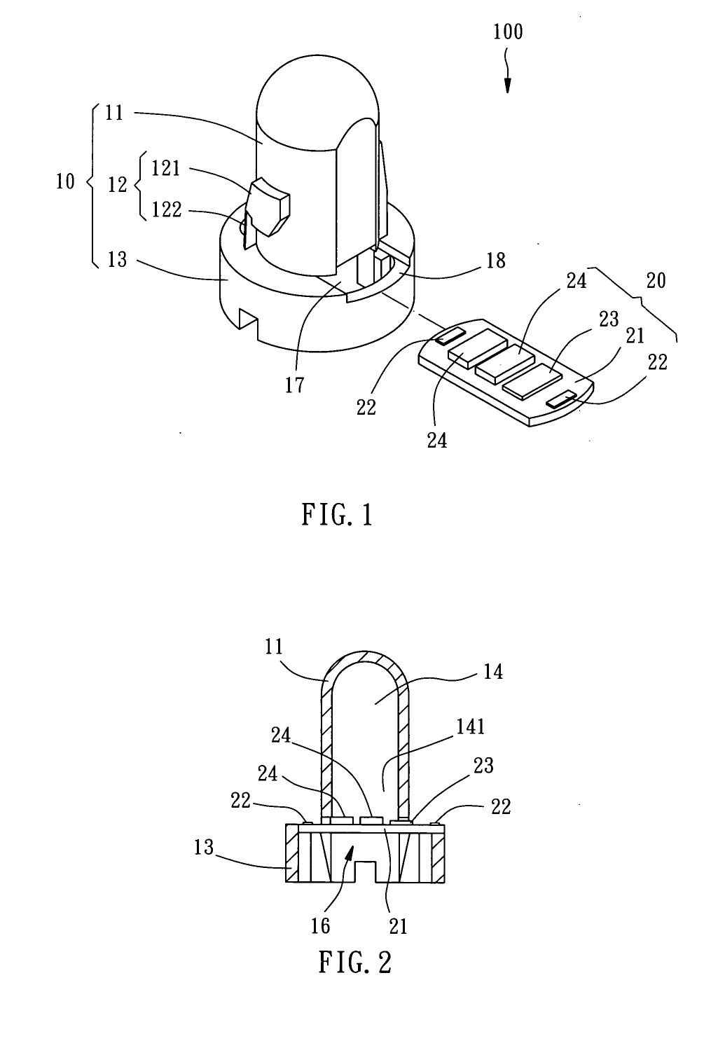

Referring to FIGS. 1 and 2, an LED lamp assembly 100 is shown comprising a lamp holder 10, and a light-emitting board 20.

The lamp holder 10 is molded from insulating plastics, for example, polycarbonate (PC), polyethylene (PE), or polypropylene (PP). According to the present preferred embodiment, the lamp holder 10 is molded from PC for the advantages of high transmittancy and good heat and electric insulation properties. The lamp holder 10 comprises a light-transmittable shade 11, a coupler 12, and a base 13. The shade 11 is an oval-shaped hollow member, having an inside chamber 14 and a bottom opening 141 at the bottom side of the inside chamber 14. According to the present preferred embodiment, the coupler 12 is embodied as two mounting members. The two mounting members 12 are provided at two sides of the peripheral wall of the shade 11, each comprising a stop block 121 and an engagement strip 122. The stop block 121 extends from the peripheral wall of the shade 11. The engagement strip 122 extends downwards from one lateral side of the stop block 121. The base 13 is shaped like a short cylinder connected to the bottom side of the shade 11, having an inside chamber 16 in air communication with the bottom opening 141 and inside chamber 14 of the shade 11, two mounting holes 17 vertically extending through the top wall in air communication with the inside chamber 16, and an insertion hole 18 horizontally extending through the peripheral wall and a part of the top wall in communication with the mounting holes 17.

The light-emitting board 20 is a printed circuit board (PCB) on which electronic elements are installed, comprising a circuit board 21, two contact members 22, a resistor 23, and two LEDs (light emitting diode) 24. The circuit board 21 has a circuit pattern (not shown) at the top side thereof. The two contact members 22 are formed of solder paste or any suitable electrically conductive material, and respectively provided at the top surface of the circuit board 21 near the two distal ends and electrically connected to the circuit pattern. The two LEDs 24 are installed in the top side of the circuit board 21 and electrically connected to the circuit pattern. The resistor 23 can be a plug type resistor or chip resistor installed in the top side of the circuit board 21 near the center area, and electrically connected to the circuit pattern for regulating the voltage and current passing through the circuit pattern.

The assembly process and advantages of the LED lamp assembly 100 will be described hereinafter.

After molding of the lamp holder 10 and preparation of the light-emitting board 20, the light-emitting board 20 is inserted through the insertion hole 18 into the inside chamber 16 of the base 13, as shown in FIG. 2. At this time, the two contact members 22 of the light-emitting board 20 are respectively exposed to the mounting holes 17, the light-emitting board 20 is formed supported in the base 13 of the lamp holder 10 by the bottom edge of the insertion hole 18, and the LEDs 24 are respectively aimed at the bottom opening 141 and inside chamber 14 of the shade 11. When the LEDs 24 are turned on to give off light, the light of the LEDs 24 passes the inside chamber 14 and the wall of the shade 11 to the outside.

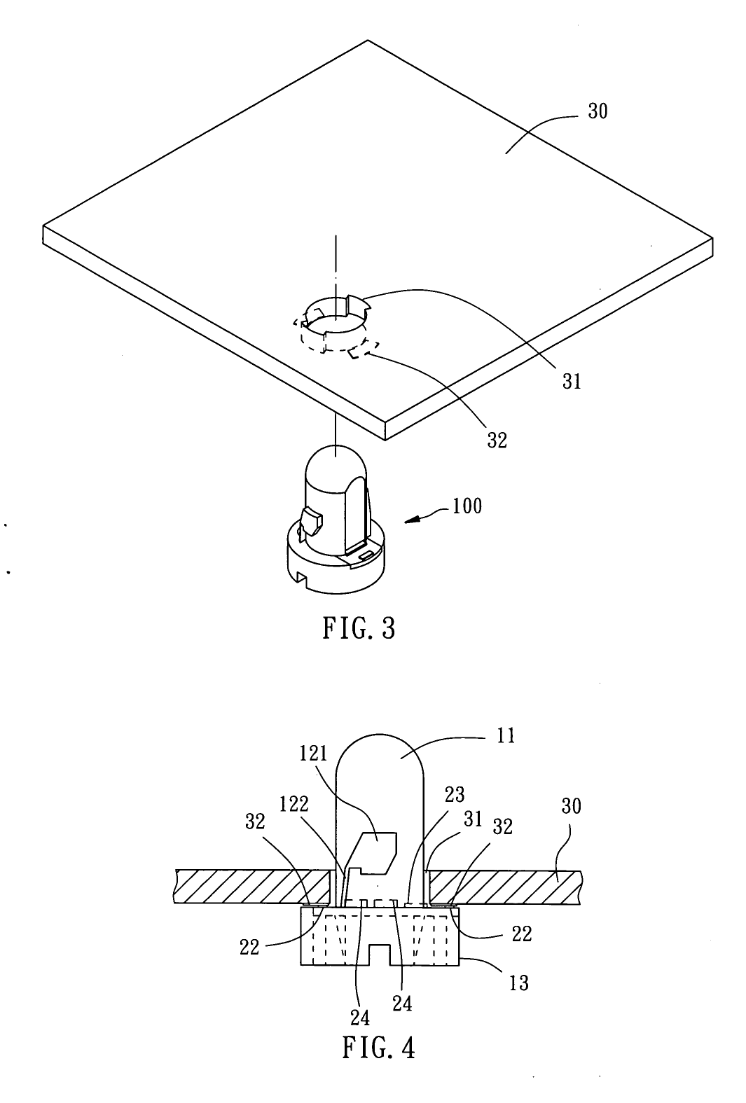

After installation of the light-emitting board 20 in the lamp holder 10, the LED lamp assembly 100 can then be installed in a control circuit board 30 as shown in FIG. 3.

As shown in FIGS. 3 and 4, the control circuit board 30 has a mounting through hole 31, and two contact members 32 disposed at the bottom wall at two sides of the mounting through hole 31 and electrically connected to the circuit (not shown) thereof. The shade 11 and mounting members 12 of the lamp holder 10 of the LED lamp assembly 100 are inserted through the mounting through hole 31 of the control circuit board 30 from the bottom side toward the top side to the extent where the top wall of the base 13 is stopped at the bottom wall of the control circuit board 30, and then the LED lamp assembly 100 is rotated through an angle relative to the control circuit board 30 to force the stop block 121 of each mounting member 12 into engagement with the top wall of the control circuit board 30 and to let the engagement strip 122 of each mounting member 12 be stopped against a part of the notched peripheral wall of the mounting through hole 31, and therefore the LED lamp assembly 100 is firmly secured to the control circuit board 30. At this time, the contact members 22 of the light-emitting board 20 are kept in close contact with the contact members 32 of the control circuit board 30, enabling the control circuit board 30 to control the operation of the LED lamp assembly 100.

As indicated above, the invention has the resistor, contact members and LEDs be installed in a circuit board to form a light-emitting board 20, and has the transparent lamp holder 10 be provided with an insertion hole 18 for easy installation of the prepared light-emitting board 20 in the lamp holder 10 to form the desired LED lamp assembly 100. This design simplifies the installation process.

Further, solder balls or metal wires may be added to the contact members (tin paste) to increase the height, ensuring positive electric connection of the LED lamp assembly 100 to the control circuit board 30.

According to the aforesaid preferred embodiment of the present invention, the resistor is installed in the top wall of the circuit board. Alternatively, the resistor can be installed in the bottom wall of the circuit board to facilitate dissipation of heat.

Further, the shade of the lamp holder has a spacious inside chamber for quick dissipation of heat during the operation of the LEDs. The formation of the inside chamber of the shade of the lamp holder makes the wall thickness of the shade relatively thinner. Therefore, the shade of the lamp holder does not refract the light of the LEDs, and can gather the light of the LEDs.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An LED lamp assembly comprising:
a lamp holder having a light-transmittable shade and a base at a bottom side of said shade, said shade having an inside chamber and a bottom opening at the bottom side thereof in communication with the inside chamber, said base having an inside chamber in communication with the bottom opening and the inside chamber of said shade; and
a light-emitting board mounted in the inside chamber of said lamp holder, said light-emitting board having a circuit board, a resistor installed in said circuit board, at least one light emitting diode installed in said circuit board and electrically connected to said resistor, and two contact members installed in said circuit board and electrically connected to said resistor and said light emitting diode for electric connection to an external electricity.

2. The LED lamp assembly as claimed in claim 1, wherein said lamp holder is molded from electrically insulative plastics.

3. The LED lamp assembly as claimed in claim 1, wherein said lamp holder is molded from polycarbonate.

4. The LED lamp assembly as claimed in claim 1, wherein said lamp holder further comprises a coupler disposed on shade for fastening said lamp holder to an external object.

5. The LED lamp assembly as claimed in claim 4, wherein said coupler comprises two mounting members provided at two opposite sides of a periphery of said shade, each said mounting member comprising a stop block extending from the periphery of said shade and an engagement strip extending downwards from one lateral side of said stop block.

6. The LED lamp assembly as claimed in claim 1, wherein said base of said lamp holder comprises two mounting holes vertically extending through a top wall thereof; wherein the contact members of said light-emitting board are exposed through said two mounting holes to the outside of said lamp holder.

7. The LED lamp assembly as claimed in claim 6, wherein said base of said lamp holder further comprises an insertion hole horizontally extending through a periphery and a part of the top wall thereof in communication with said mounting holes for the insertion of said light-emitting board into said lamp holder.

8. The LED lamp assembly as claimed in claim 1, wherein said base of said lamp holder further comprises an insertion hole in communication with the inside chamber of said base for the insertion of said light-emitting board into said lamp holder.

9. The LED lamp assembly as claimed in claim 1, wherein said circuit board of said light-emitting board comprises a circuit pattern at a top wall thereof; said contact members of said light-emitting board are installed in the top wall of said circuit board near two distal ends and electrically connected to said circuit pattern; said light emitting diode is installed in the top wall of said circuit board and electrically connected to said circuit pattern and aimed at the inside chamber of said shade of said lamp holder; said resistor is installed in said circuit board and electrically connected to said circuit pattern.

10. The LED lamp assembly as claimed in claim 9, wherein said contact members are formed of tin paste.
